(19) United States
(12) Patent Application Publication
(10) Pub. No.: US 2008/0106756 A1
(43) Pub. Date: May 8, 2008

(54) Document managing system and computer readable medium

(75) Inventor: Mugen Okamoto, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/878,090

(22) Filed: Jul. 20, 2007

(30) Foreign Application Priority Data
Nov. 8, 2006 (JP) 2006-302326

(51) Int. Cl. G06F 3/12

(52) U.S. Cl. 358/1.15; 358/1.16

(57) ABSTRACT

A document managing system includes: a document managing device that forms and manages, in a case where an instruction for printing and outputting a plurality of copies of a document is received from a user, identifying codes respectively corresponding to a plurality of copies of printed matters of one document related to the instruction, and that attaches the identifying codes to the printed matters respectively corresponding thereto; and a discarding device that has a mechanism discarding the printed matters to read the identifying codes attached to the printed matters and inform the document managing device of the read identifying codes in a case where the printed matters are discarded.

### CROSS-REFERENCE TO RELATED APPLICATIONS

This application is based on and claims priority under 35 U.S.C. 119 from Japanese Patent Application No. 2006-302326 filed Nov. 8, 2006.

### BACKGROUND

### 1. Technical Field

The present invention relates to a document managing system and a computer readable medium for managing the output to the discard of sheets of a document.

### SUMMARY

According to an aspect of the present invention, a document managing system includes: a document managing device that forms and manages, in a case where an instruction for printing and outputting a plurality of copies of a document is received from a user, identifying codes respectively corresponding to a plurality of copies of printed matters of one document related to the instruction, and that attaches the identifying codes to the printed matters respectively corresponding thereto; and a discarding device that has a mechanism discarding the printed matters to read the identifying codes attached to the printed matters and inform the document managing device of the read identifying codes in a case where the printed matters are discarded.

### BRIEF DESCRIPTION OF THE DRAWINGS

Exemplary embodiment of the present invention will be described in detail based on the following figures, wherein:

FIG. 1 is a block diagram for explaining a document managing system according to one embodiment;

FIG. 2 is a flowchart for explaining a flow of document managing processes;

FIG. 3 is a diagram showing an example of a table of a document managing information storing part;

FIG. 4 is a block diagram for explaining a document managing system according to another embodiment;

FIG. 5 is a flowchart for explaining a flow of document managing processes;

FIG. 6 is a flowchart for explaining a flow of document managing processes; and

FIG. 7 is a diagram showing an example of a table of a document managing information storing part.

### DETAILED DESCRIPTION

Now, an embodiment of the present invention will be described below by referring to the drawings. Namely, a document managing system according to this embodiment can manage together plural of documents formed during a printing operation. In this embodiment, when a user prints the plural documents, the document managing system informs the user of what number of documents being discarded among the printed documents. Thus, the user can grasp and certify that the plural copies of the documents printed from an original document are properly discarded. Further, since identifying codes respectively corresponding to the plural copies of the printed matters are formed to tie and manage the users to whom the printed matters are supplied, the user who does not properly discard the document can be detected, warned and urged to discard the document. Therefore, a risk can be characteristically reduced that the document is not discarded and left to cause information to leak.

Namely, a related art has managed the discarding state of a document single body. However, when plural documents are printed, since plural child documents having the same information as that of a parent document are formed, it is necessary to show that all the child documents are discarded in order to certify that the information of the parent document is discarded. In this embodiment, a unit is provided by which the user knows that document information formed during printing the document is discarded by managing the discarding state of the plural child documents printed from the parent document in a document managing device.

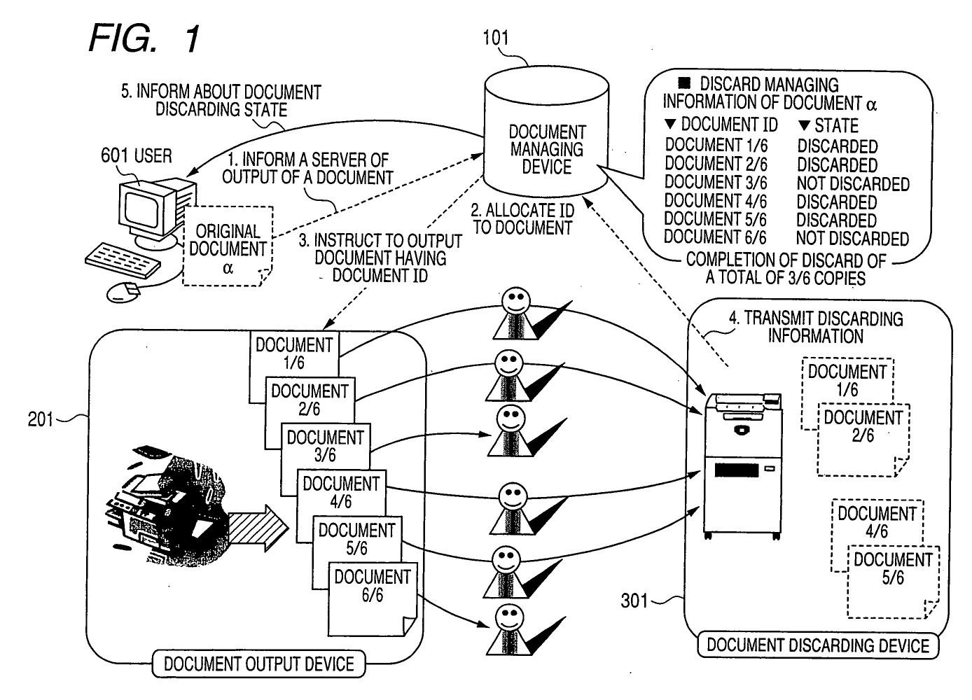

FIG. 1 is a block diagram for explaining the document managing system according to this embodiment. That is, the document managing system according to this embodiment mainly includes a document managing device 101 and a document discarding device 301. Further, a document managing program of this embodiment is software mainly executed by the document managing device 101, and recorded on a previous medium or distributed through a previous line.

When the document managing device 101 receives an instruction from a user 601 who prints and outputs plural copies of a document, the document managing device 101 forms document IDs (identifying codes) respectively corresponding to the plural copies of printed matters relative to one document related to the instruction, manages the document IDs in a table and supplies an output instruction to a document output device 201 to attach the document IDs to the printed matters respectively corresponding thereto.

The document managing device 101 is included in, for instance, the document output device (a printer) or the document discarding device or provided as a server on a network.

The document discarding device 301 includes a mechanism for discarding the printed matters by shredding the printed matters and a mechanism for reading the document IDs attached to the printed matters to discard the printed matters. That is, when the printed matters are supplied to an insert port to discard the printed matters, the document IDs attached to the printed matters can be read by an optical sensor disposed from the insert port to the discarding mechanism.

Further, a mechanism is provided for informing the document managing device 101 of the document IDs read before the discarding process of the printed matters through the prescribed line.

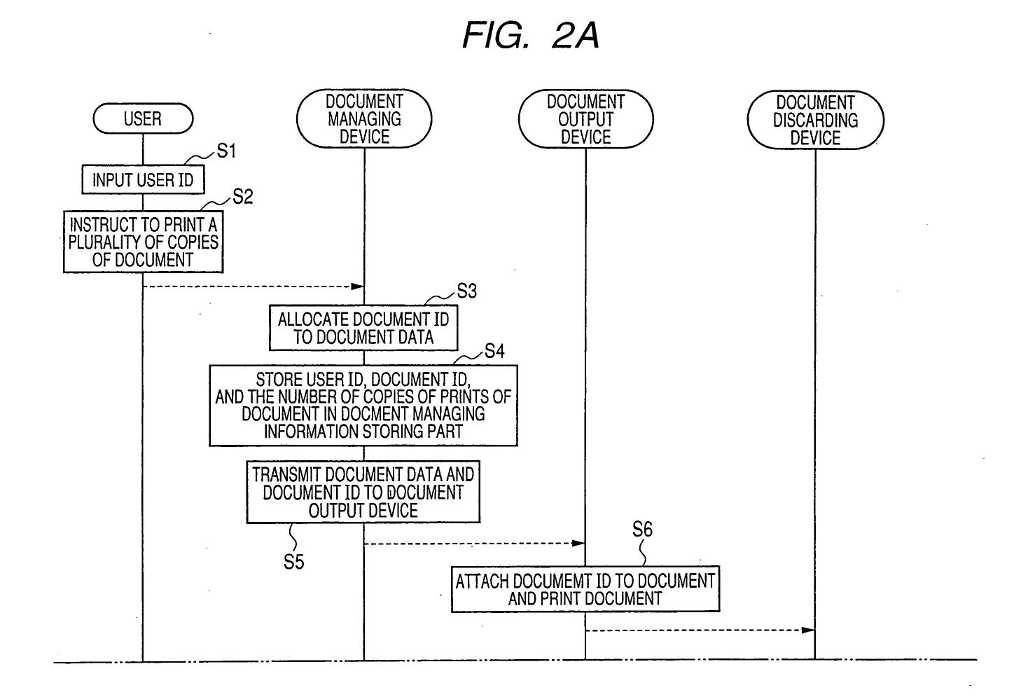

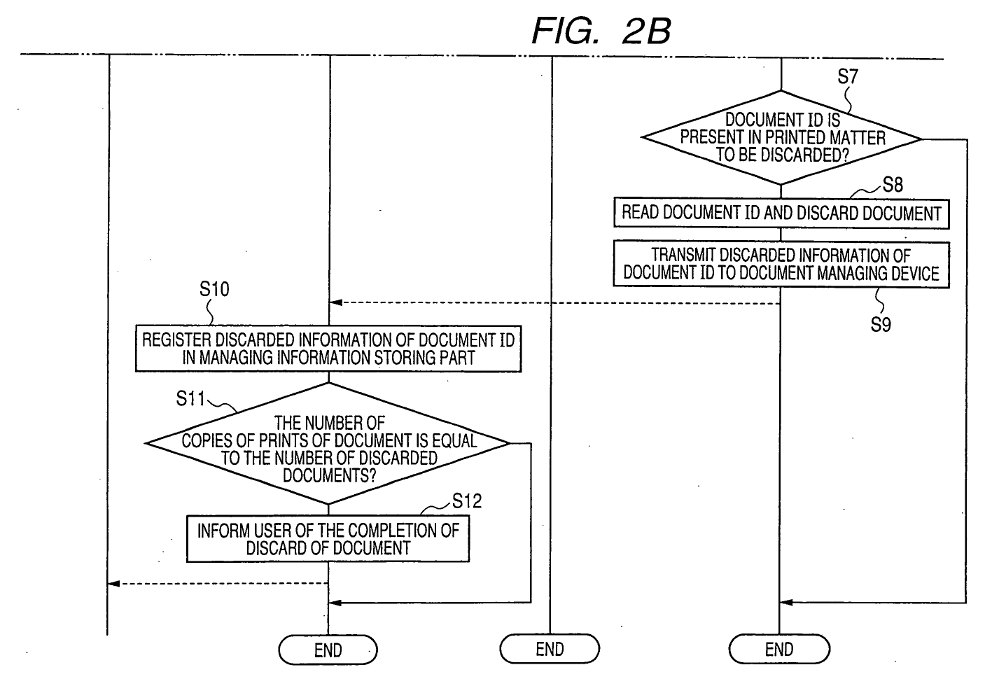

Now, a flow of document managing processes in the above-described document managing system will be described below. FIG. 2 is a flowchart for explaining the flow of the document managing processes. Processes in the document managing device in this flowchart form the document managing program of this embodiment.

Firstly, the document managing device receives a user ID, document data of an original document a instructed to be printed and the number of copies of prints from the user through the network (steps S1 to S2). When the user outputs plural copies of the document by a copying machine, the document data obtained by scanning the original document α may be received.

Then, the document managing device allocates the document ID to the received document data (step S3). At this time, the document ID is allocated to each copy of the one document data that the user instructs to print. Further, the document ID for each copy is managed in a table so as to indicate the original document a.

Specifically, as shown in FIG. 1, for instance, when six copies of the original document α are instructed to be printed and outputted, the document IDs are respectively attached to the six copies correspondingly to the document α and these document Ids are managed in the table.

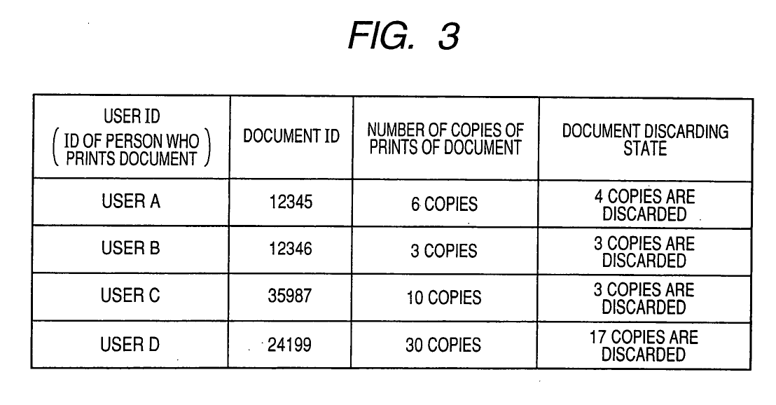

Then, the document IDs and the number of prints of the document are held in a document managing information storing part provided in the document managing device (step S4). FIG. 3 shows an example of a table of the document managing information storing part. In this table, the ID of the user who instructs to print the document, the document ID, the number of copies of the prints of the document and a document discarding state are managed. For instance, when a user A prints the document, the document ID “12345” attached to the document is registered and the number of copies of the prints “six copies” is also registered correspondingly thereto.

Further, the document managing information storing part includes discarding state information of the plural the documents (what number of prints of the document are discarded) for the document ID. In the example shown in FIG. 3, the document discarding state “four copies are already discarded” is registered correspondingly to the document ID “12345” of the document printed by the user A. The table may include setting information of a method for managing the document. Further, the setting information of the method for managing the document may be received simultaneously with the document data for instructing to print the document transmitted from the user and held in the document managing information storing part.

When the document data originally has the document ID, the document managing device examines the document managing information storing part. When the same document ID exists, the document managing device may update the managing table of the document ID to carry out subsequent processes.

Then, the document data and the document ID are transmitted from the document managing device to the document output device (step S5). Then, the document output device receives the document data and the document ID from the document managing device to attach the document ID to the document to be printed and print the document (step S6). The document ID to be attached is attached to the document in the form of, for instance, a two-dimensional code, a bar code, a character string and an ID chip. When the plural copies of the document are printed, the document IDs respectively corresponding to the copies are attached thereto.

Subsequently, the printed documents (printed matters) are distributed. After that, when the printed matters are discarded, the document discarding device decides whether or not the document IDs are attached to the printed matters to be discarded (step S7). Here, when the document IDs are not attached to the printed matters, the process is finished.

On the other hand, when the document IDs are attached to the printed matters, the document IDs are read, and then, the printed matters are discarded (step S8). The document discarding device informs the document managing device of the read document IDs and information that the printed matters are discarded (step S9).

The document managing device receives the document IDs of the discarded documents and the information (document discarded information) that the documents are discarded which are reported from the document discarding device to collate the document IDs of the discarded documents with information stored in the document managing information storing part and update (count up) the discarding state information of the plural documents having the same document IDs as the received document IDs in the document managing information storing part (step S10).

Then, the document managing device decides whether or not the number of copies of the prints of the document is the same as the number of the discarded documents (step S11). That is, after the discarding state information is updated, the number of the discarded documents corresponding to the updated document IDs is compared with the number of copies of the prints of the document to decide whether or not they are equal to each other. Then, when the number of the discarded documents is equal to the number of copies of the prints of the document, information showing the completion of the discard of the documents is transmitted to the user who instructs to print the document (step S12).

Namely, when the number of the discarded documents is equal to the number of copies of the prints of the document, all the printed matters of the plural copies printed from the document are discarded to inform the user who prints the document of a discard completion certificate by an electronic mail. On the other hand, when the number of the discarded documents is not equal to the number of copies of the prints, since any of the plural copies of the prints are not yet discarded, the information of completion is not transmitted to the user to finish the process. Thus, even when the plural copies of the prints is formed from one document, whether or not all the printed matters are discarded can be assuredly managed.

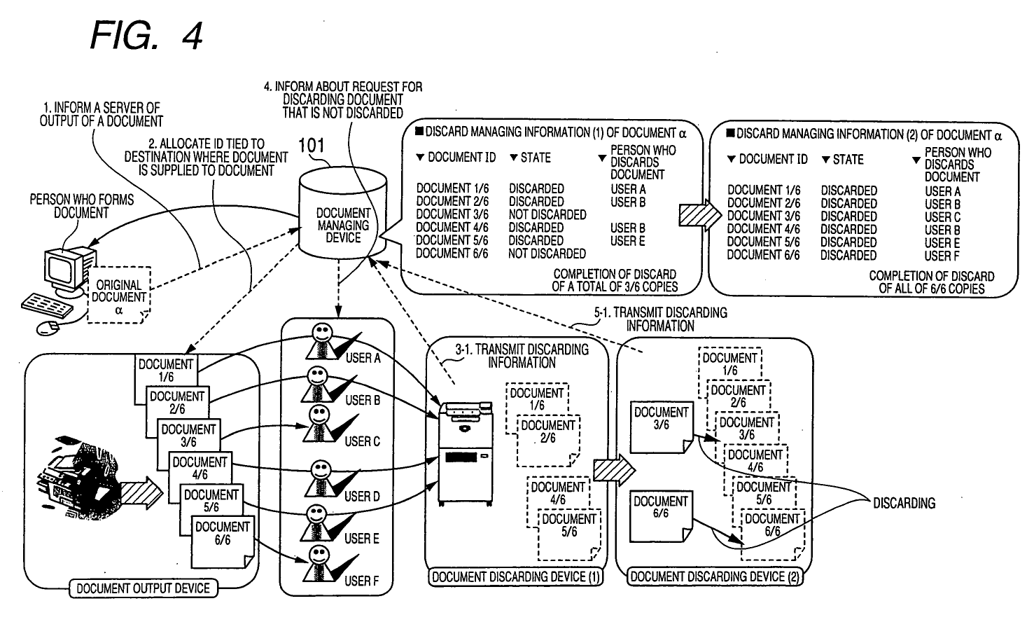

Now, another embodiment will be described. FIG. 4 is a block diagram for explaining another embodiment. A document managing system of another embodiment additionally includes a management of the term of validity.

That is, the document managing system according to another embodiment mainly includes a document managing device 101 and a document discarding device 301. Further, a document managing program of this embodiment is software mainly executed by the document managing device 101, and recorded on a previous medium or distributed through a previous line.

When the document managing device 101 receives an instruction from a user 601 who prints and outputs plural copies of a document, the document managing device 101 forms document IDs (identifying codes) respectively corresponding to the plural copies of printed matters relative to one document related to the instruction, manages the document IDs in a table and supplies an output instruction to a document output device 201 to attach the document IDs to the printed matters respectively corresponding thereto.

Further, the document managing device 101 includes a function for managing the term of validity correspondingly to the one document instructed to be printed to decide whether or not the document corresponding to the identifying code is located within the term of validity in accordance with the identifying code reported from the document discarding device. When the document is not located within the term of validity and other printed matters are not yet discarded, the user 601 who instructs to print and output the document is informed of the thing.

The document managing device 101 is included in, for instance, the document output device (a printer) or the document discarding device or provided as a server on a network.

The document discarding device 301 includes a mechanism for discarding the printed matters by shredding the printed matters and a mechanism for reading the document IDs attached to the printed matters to discard the printed matters. That is, when the printed matters are supplied to an insert port to discard the printed matters, the document IDs attached to the printed matters can be read by an optical sensor disposed from the insert port to the discarding mechanism.

Further, a mechanism is provided for informing the document managing device 101 of the document IDs read before the discarding process of the printed matters through the prescribed line.

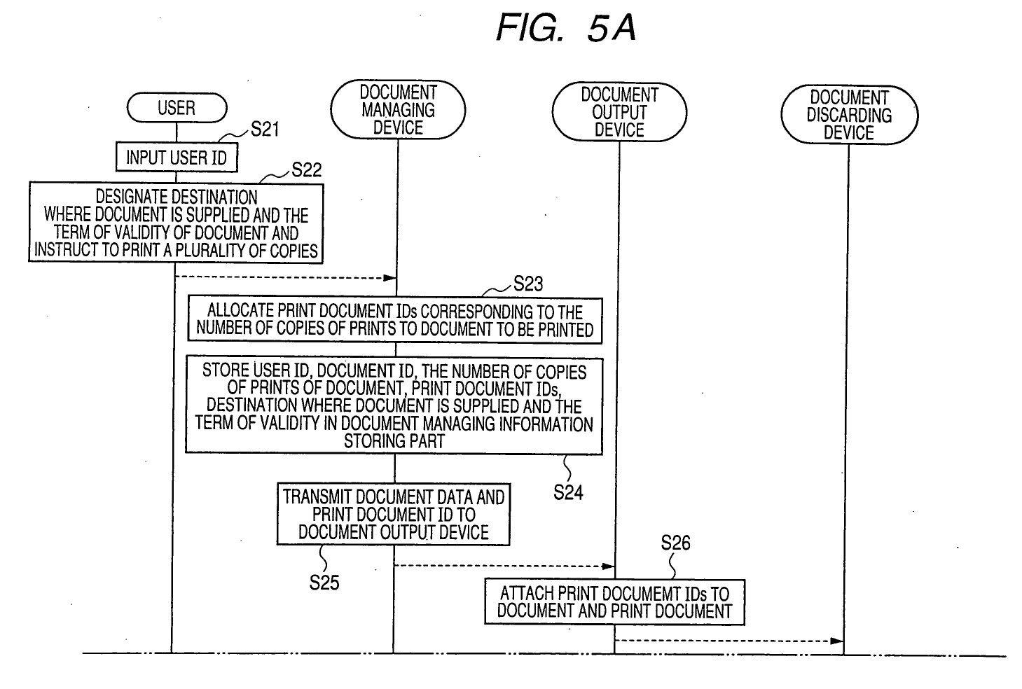

Now, a flow of document managing processes in the document managing system according to another embodiment will be described below. FIG. 5 is a flowchart for explaining the flow of the document managing processes. Processes in the document managing device in this flowchart form the document managing program of this embodiment.

Firstly, the user inputs a user ID (step S21) to designate document data of an original document α, the number of copies of prints, a destination to which the document is supplied and the term of validity of the document (step S22). The document managing device receives the user ID, the document data of the original document α instructed to be printed, the number of copies of the prints, the destination to which the document is supplied and the term of validity of the document through the network to store them in a table for managing the information of a “print document ID”, the “destination to which the document is supplied” and the “term of validity of the document” respectively corresponding to the copies in a document managing information storing part (step S24). Here, the print document ID is related to the document IDs attached to the one document and means the identifying codes respectively attached to the printed matters when the plural copies of the document are printed.

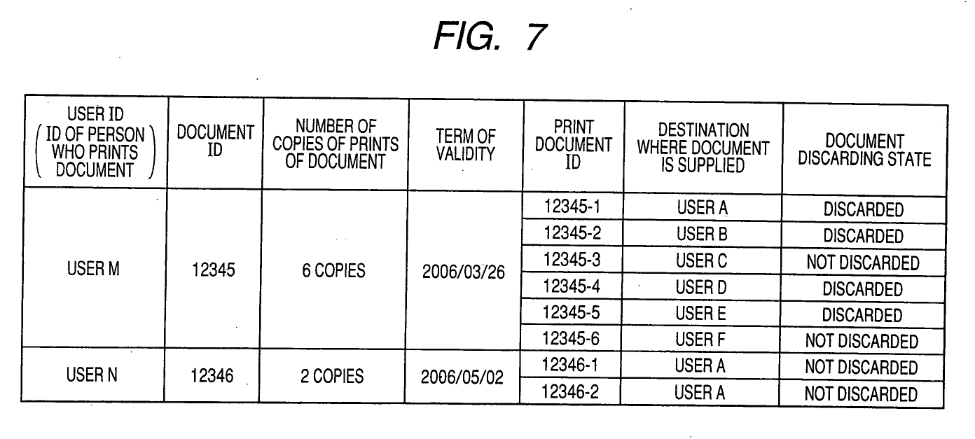

FIG. 7 shows an example of the table of the document managing information storing part. In this table, the ID of the user who instructs to print the document, the document ID, the number of copies of the prints of the document, the term of validity of the document, the print document ID, the destination to which the document is supplied and a document discarding state are managed. In this example, as the print document ID, consecutive numbers respectively for the copies that are attached to the corresponding document ID are employed.

Further, the document managing information storing part includes a table for managing discarding state information of the plural the documents (what number of copies of the prints of the document are discarded) for the document ID and setting information of a method for managing the document. Further, the setting information of the method for managing the document may be received simultaneously with document data for instructing to print the document transmitted from the user and held in the document managing information storing part.

When the document data originally has the document ID, the document managing device examines the document managing information storing part. When the same document ID exists, the document managing device may update the managing table of the document ID to carry out subsequent processes.

Then, the document data and the document ID are transmitted from the document managing device to the document output device (step S25). Then, the document output device receives the document data and the print document ID from the document managing device to attach the print document ID to the document to be printed and print the document (step S26). The print document ID to be attached is attached to the document in the form of, for instance, a two-dimensional code, a bar code, a character string and an ID chip. Thus, the print document IDs are respectively attached to the plural the printed matters printed from the document.

Subsequently, the printed documents (printed matters) are distributed. After that, when the printed matters are discarded, the document discarding device decides whether or not the print document IDs are attached to the printed matters to be discarded (step S27). Here, when the print document IDs are not attached to the printed matters, the process is finished.

On the other hand, when the print document IDs are attached to the printed matters, the print document IDs are read, and then, the printed matters are discarded (step S28). Further, the document discarding device informs the document managing device of the read print document IDs and information that the printed matters are discarded (step S29). Further, the user for discarding the printed matters may be identified and transmitted to the document managing device as a person who discards the document as well as the print document IDs to manage the person who discards the document.

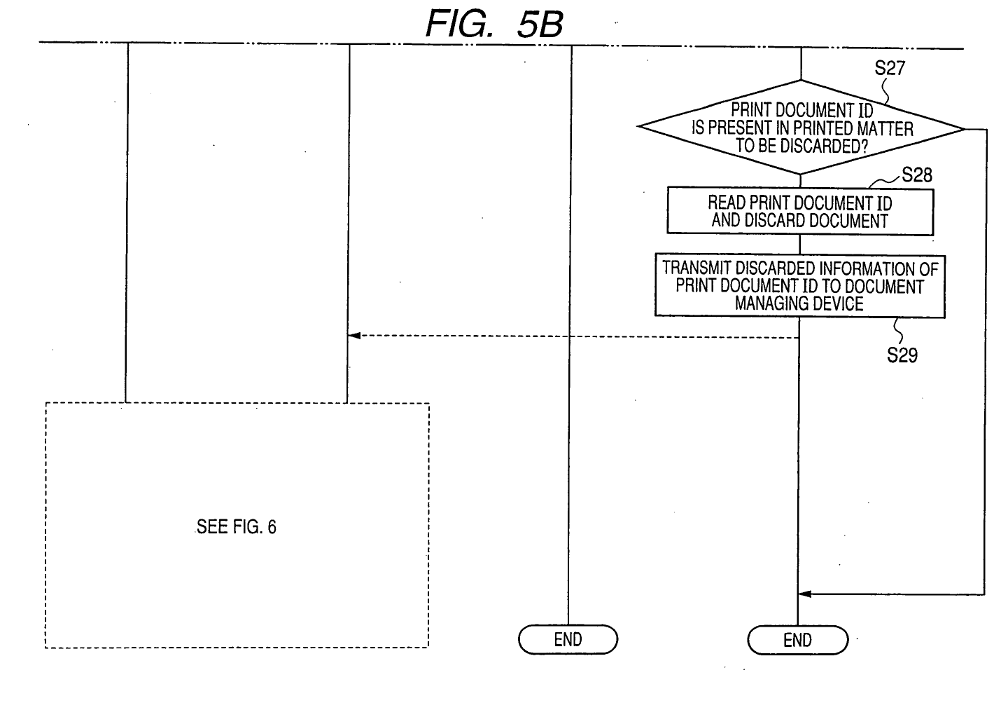

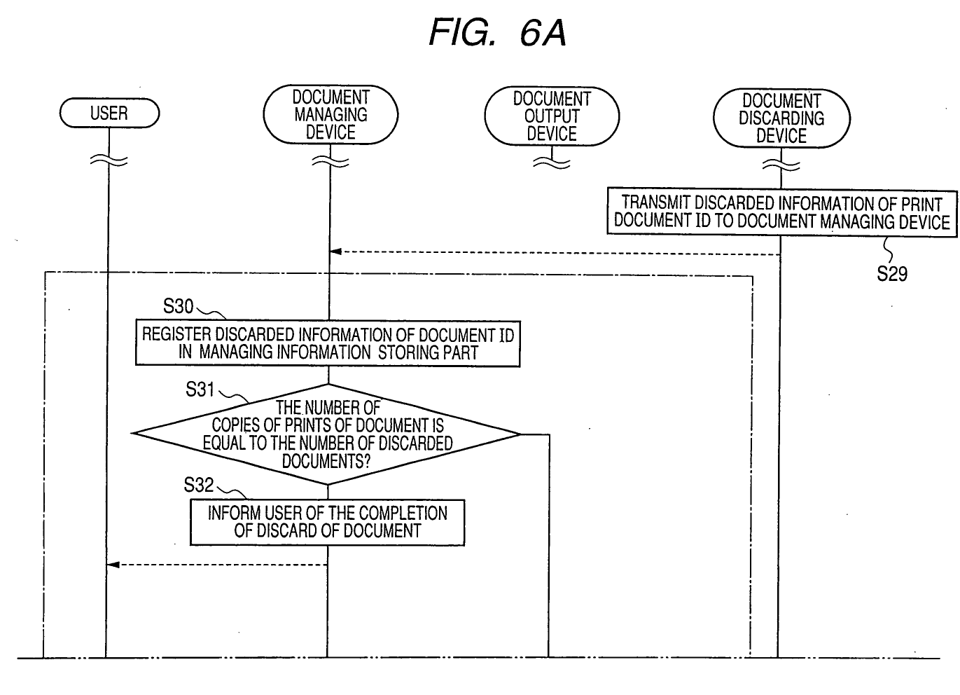

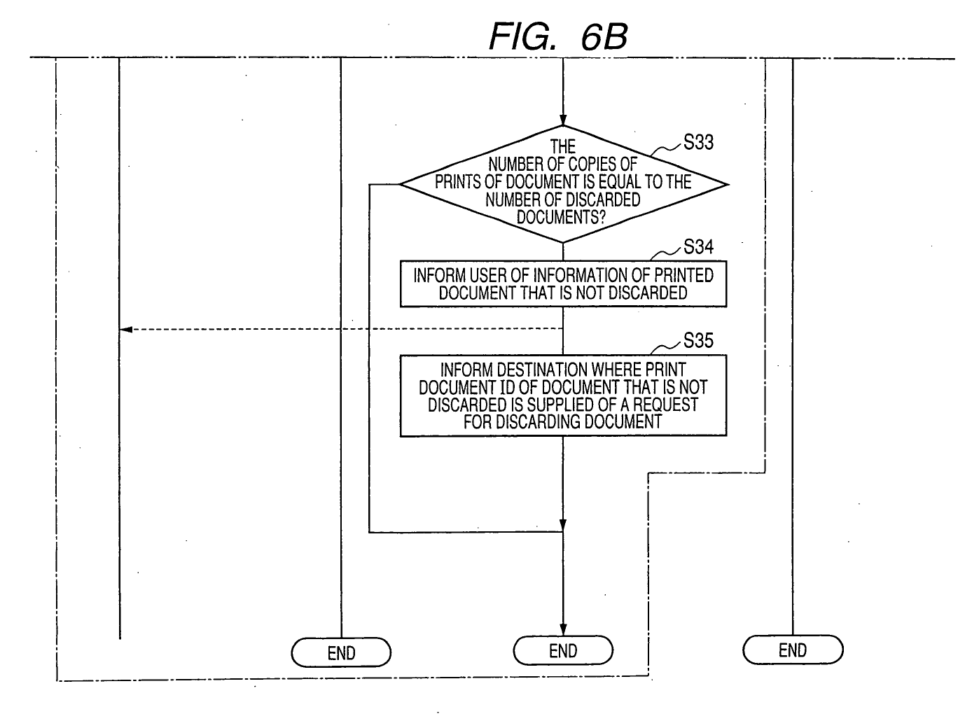

Processes after the above-described processes (within a frame shown by a dashed line in FIG. 5) are shown in a diagram A of a flowchart shown in FIG. 6. The managing device registers the print document IDs to be discarded that are reported from the document discarding device in the document managing information storing part (step S30) to decide whether or not the number of copies of the prints of the document is equal to the number of the discarded documents (step S31). Then, when the number of copies of the prints of the document is equal to the number of the discarded documents, the document managing device transmits information showing the completion of the discard of the document to the user who instructs to print the document (step S32).

On the other hand, when the number of the discarded documents is not equal to the number of copies of the prints, the term of validity of the document corresponding to the print document IDs is referred to decide whether or not the document is located within the term of validity (step S33). When the document is located within the term of validity, the process is finished.

On the other hand, when the document passes the term of validity, the user who instructs to print the document is informed that even when the printed matters pass the term of validity, they are not yet discarded (step S34). Further, a request for discarding the document is transmitted to the destination where the document is supplied and the document is not yet discarded among the destinations where the document tied to the print document IDs is supplied (step S35). When all the statuses (document discarding states) of the print document IDs show that the document has been already discarded, a person who forms the document may be informed of the completion of the discard of the document or a document discard completion certificate may be issued.

Now, a specific example will be described. As shown in FIG. 4, when the document managing device receives an instruction for printing and outputting six copies of an original document a from the user, the document managing device attaches the print document IDs respectively to the copies and registers the destinations to which the copies are respectively supplied (here, a user A to a user F) in the table of the document managing information storing part (see FIG. 7).

Under these circumstances, it is assumed that some of the printed matters are discarded. For instance, when the printed matters supplied to the user A, the user B, the user D and the user E are discarded in a document discarding device (1), the document discarding device (1) reads the print document IDs attached respectively to the printed matters to inform the document managing device 101 of the thing.

The document managing device receives the print document IDs reported from the document discarding device (1) to register information showing that the printed matters are already discarded in the table corresponding thereto. Further, when the document managing device receives the information of the user who discards the printed matters, the document managing device may register the information of the user. In the example shown in FIG. 4, the users A and E discard the printed matters supplied to them by themselves and the user B discards the printed matter supplied to the user B and the printed matter supplied to the user D.

Here, when the document managing device compares the number of copies of the prints with the number of the discarded copies of the prints and they do not correspond to each other, the document managing device refers to the term of validity of the document. Then, when the document passes the term of validity, information for urging the printed matters to be discarded is transmitted by for instance, an electronic mail to the user as the destination to which the printed matter corresponding to the print document ID that is not yet discarded is supplied. In this example, since the printed matters supplied to the user C and the user F are not yet discarded, the user C and the user F are informed of a message of “the printed matters passing the term of validity have not been discarded”. Further, the user of the original document a who instructs to print the document is also informed of the existence of the printed matter that passes the term of validity and is not yet discarded.

Then, when the printed matters supplied to the user C and the user F are discarded in a document discarding device (2), the document discarding device informs the document managing device of the read print document IDs and registers information showing that the printed matters are already discarded in the corresponding parts of the table of the document managing information storing part. When the number of copies of the prints corresponds to the number of copies of the discarded documents, information showing that all the printed matters are completely discarded is transmitted to the user who instructs to print the original document α. Thus, even when the plural copies are printed from the one document, whether or not all the printed matters are discarded and whether or not the printed matters that pass the term of validity and are not discarded remain can be assuredly managed.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A document managing system comprising:
a document managing device that forms and manages, in a case where an instruction for printing and outputting a plurality of copies of a document is received from a user, identifying codes respectively corresponding to a plurality of copies of printed matters of one document related to the instruction, and that attaches the identifying codes to the printed matters respectively corresponding thereto; and
a discarding device that has a mechanism discarding the printed matters to read the identifying codes attached to the printed matters and inform the document managing device of the read identifying codes in a case where the printed matters are discarded.

2. The document managing system as claimed in claim 1, wherein the document managing device receives the identifying codes reported from the document discarding device to write information that the printed matters are already discarded about the identifying codes managed correspondingly to the plurality of copies of the printed matters of the one document.

3. The document managing system as claimed in claim 1, wherein, in a case where the document managing device receives the identifying codes reported from the discarding device, the document managing device informs the user who instructs to print and output the document corresponding to the identifying codes that the document managing device receives the identifying codes.

4. The document managing system as claimed in claim 1, wherein the document discarding device recognizes the user who instructs to discard the printed matters to inform the document managing device of the user in a case where the discarding device discards the printed matters.

5. The document managing system as claimed in claim 4, wherein, in a case where the document managing device receives the information of the user who instructs to discard the printed matters and the identifying codes attached to the printed matters from the discarding device, the document managing device writes information indicating that the user discards the printed matters about the identifying codes managed correspondingly to the plurality of copies of the printed matters of the one document.

6. The document managing system as claimed in claim 2,
wherein
the document managing device decides whether or not all the printed matters of the one document corresponding to the identifying codes are already discarded on the basis of the identifying codes reported from the document discarding device, and,
in a case where all the printed matters are already discarded, the document managing device informs the user who instructs to print and output the document that the printed matters are already discarded.

7. The document managing system as claimed in claim 1,
wherein
the document managing device manages the term of validity correspondingly to the one document to decide whether or not the document corresponding to the identifying codes is located within the term of validity in accordance with the identifying codes reported from the discarding device, and,
in a case where the document is not located within the term of validity and any printed matters of the document are not yet discarded, the document managing device informs the user who instructs to input and output the document that the document is not located within the term of validity and any printed matters are not yet discarded.

8. A computer readable medium storing a program causing a computer to execute a process for managing a document, the process comprising:
forming and managing in a table, in a case where an instruction for printing and outputting a plurality of copies of the document is received from a user, identifying codes respectively corresponding to a plurality of copies of printed matters of one document related to the instruction,
attaching the identifying codes to the printed matters respectively corresponding thereto; and
receiving the identifying codes attached to the printed matters in a case where the printed matters are discarded to write information that the printed matters are already discarded about the identifying codes managed in the table correspondingly to the plurality of copies of the printed matters of the one document.

9. The computer readable medium as claimed in claim 8, further comprising:
informing, in a case where the identifying codes reported from the discarding device are received, the user who instructs to print and output the document corresponding to the identifying codes to a reception of the identifying codes.

10. The computer readable medium as claimed in claim 8, further comprising:
writing, in a case where the information of the user who instructs to discard the printed matters and the identifying codes attached to the printed matters are received from the discarding device, information indicating that the user discards the printed matters about the identifying codes managed in the table correspondingly to the plurality of copies of the printed matters of the one document.

11. The computer readable medium as claimed in claim 8, further comprising:
deciding whether or not all the printed matters of the one document corresponding to the identifying codes are already discarded on the basis of the identifying codes reported from the document discarding device; and
informing the user who instructs to print and output the document that the printed matters are already discarded, in a case where all the printed matters are already discarded.

12. The computer readable medium according to claim 8, further comprising:
managing the term of validity correspondingly to the one document;
deciding whether or not the document corresponding to the identifying codes is located within the term of validity in accordance with the identifying codes reported from the discarding device; and
informing the user who instructs to input and output the document that the document is not located within the term of validity and any printed matters of the document are not yet discarded, in a case where the document is not located within the term of validity and any printed matters are not yet discarded.
